(19) United States
(12) Patent Application Publication
(10) Pub. No.: US 2006/0115711 A1
(43) Pub. Date: Jun. 1, 2006

(54) Electrode for fuel cell, fuel cell comprising the same, and method for preparing the same

(76) Inventors: Hee-Tak Kim, Suwon-si (KR); Ho-Jin Kweon, Suwon-si (KR); Jong-Ki Lee, Suwon-si (KR)

Correspondence Address: CHRISTIE, PARKER & HALE, LLP, PO BOX 7068, PASADENA, CA, 91109-7068, US

(21) Appl. No.: 11/288,887

(22) Filed: Nov. 28, 2005

(30) Foreign Application Priority Data
Nov. 26, 2004 (KR) 10-2004-0097952

(51) Int. Cl. H01M 4/96; H01M 4/92; H01M 8/10; H01M 4/88; B05D 5/12

(52) U.S. Cl. 429/44; 429/30; 429/33; 502/101; 427/115

(57) ABSTRACT

An electrode for a fuel cell of the present invention includes an electrode substrate, a microporous layer formed on the surface of the electrode substrate, and a nano-carbon layer formed on the surface of the microporous layer with a catalyst layer coated on the surface of the nano-carbon layer. Alternatively, an electrode for a fuel cell includes an electrode substrate in which carbon particles are dispersed, a nano-carbon layer on the electrode substrate, and a catalyst layer on the nano-carbon layer.

### CROSS REFERENCE TO RELATED APPLICATION

This application claims priority to and the benefit of Korean Patent Application No. 10-2004-0097952 filed in the Korean Industrial Property Office on Nov. 26, 2004, the contents of which are incorporated hereinto by reference.

### FIELD OF THE INVENTION

The present invention relates to an electrode for a fuel cell, a fuel cell including the same, and a method for preparing the same, and more particularly to an electrode which has a large surface area and thus improves electrochemical reaction, a fuel cell including the same, and a method for preparing the same.

### BACKGROUND OF THE INVENTION

A fuel cell is a power generation system for producing electrical energy through an electrochemical redox reaction of an oxidant and a fuel such as hydrogen, or a hydrocarbon-based material such as methanol, ethanol, or natural gas.

A fuel cell can be classified as a phosphoric acid type, a molten carbonate type, a solid oxide type, a polymer electrolyte type, or an alkaline type depending upon the kind of electrolyte used. Although each of these different types of fuel cells effectively operates in accordance with the same basic principles, they may differ from one another in the kind of the fuel, operating temperature, catalyst, and/or electrolyte used.

Recently, polymer electrolyte membrane fuel cells (PEMFCs) have been developed. They have power characteristics that are superior to conventional fuel cells, as well as lower operating temperatures and faster start and response characteristics. Because of this, PEMFCs have a wide range of applications such as for mobile power sources for automobiles, distributed power sources for houses and public buildings, and small electric sources for electronic devices.

A PEMFC is essentially composed of a stack, a reformer, a fuel tank, and a fuel pump. The stack forms a body of the PEMFC, and the fuel pump provides fuel stored in the fuel tank to the reformer. The reformer reforms the fuel to generate hydrogen and supplies the hydrogen to the stack. Fuel stored in the fuel tank is pumped to the reformer using power which can be provided by the PEMFC. Then, the reformer reforms the fuel to generate hydrogen, and the hydrogen and the oxidant are electrochemically oxidized and reduced, respectively in the stack to generate electrical energy.

Alternatively, a fuel cell may be a direct methanol fuel cell (DMFC) in which liquid methanol fuel is directly introduced to the stack. Unlike a PEMFC, a DMFC does not require a reformer.

In the above-mentioned fuel cell system, the stack for generating the electricity has a structure in which several unit cells, each having a membrane electrode assembly (MEA) and a separator (referred to also as a “bipolar plate”), are stacked adjacent one another. The MEA is composed of an anode (referred to also as a “fuel electrode” or “oxidation electrode”) and a cathode (referred to also as an “air electrode” or “reduction electrode”) that are separated by a polymer electrolyte membrane.

The separators work as passageways for supplying the fuel and the oxidant required for the reaction to the anode and the cathode, respectively, and also work as a conductor for serially connecting the anode and the cathode in the MEA. The electrochemical oxidation reaction of the fuel occurs on the anode, and the electrochemical reduction reaction of an oxidant occurs on the cathode. Due to movement of the electrons generated by the reactions, electricity, heat, and water can be collectively produced.

The anode or cathode typically includes a platinum (Pt) catalyst. However, platinum is a rare and expensive metal and thus is disadvantageous to use in a large amount. In this regard, in order to reduce the amount of platinum used, the platinum is typically supported on carbon.

However, supporting the platinum on the carbon can result in an increased thickness of the catalyst layer. Furthermore, there are limits in the amount of platinum that can be stored on the catalyst layer. Additionally, contact between this catalytic layer and the membrane may not be good, which may further deteriorate the fuel cell performance.

Therefore, it is desirable to develop an MEA for a fuel cell with a reduced amount of catalyst in the catalyst layer while still showing excellent cell performance.

### SUMMARY OF THE INVENTION

In one embodiment of the present invention, an improved electrode for a fuel cell includes a catalyst having a large surface area and an improved reaction efficiency.

In another embodiment of the present invention, an MEA for the fuel cell includes the improved electrode for the fuel cell.

In another embodiment of the present invention, a fuel cell system includes the improved electrode for the fuel cell.

In another embodiment of the present invention, a method is provided for fabricating the improved electrode for the fuel cell.

According to one embodiment of the present invention, an electrode for a fuel cell includes an electrode substrate, a microporous layer (MPL) formed on a surface of the electrode substrate, nano-carbon formed on a surface of the microporous layer, and a catalyst layer coated on a surface of the nano-carbon.

An exemplary embodiment of the present invention provides an electrode for a fuel cell which includes an electrode substrate in which carbon particles are dispersed, nano-carbon formed on a surface of the electrode substrate, and a catalyst layer coated on a surface of the nano-carbon. The electrode substrate in which the carbon particles are dispersed therein can function both as a backing layer and a dispersion layer.

An exemplary embodiment of the present invention provides a membrane-electrode assembly (MEA). The MEA includes a polymer electrolyte membrane and electrodes positioned on both sides of the polymer electrolyte membrane. Each electrode includes an electrode substrate, a microporous layer formed on a surface of the electrode substrate, nano-carbon formed on a surface of the microporous layer, and a catalyst layer coated on a surface of the nano-carbon.

An embodiment of the present invention provides an MEA that includes a polymer electrolyte membrane having first and second side surfaces, a nano-carbon layer formed on the first and second side surfaces of the polymer electrolyte membrane, and a catalyst layer coated on the surfaces of the nano-carbon. An electrode substrate is positioned on each of the first and second side surfaces of the polymer electrolyte membrane over the nano-carbon layer and the catalyst layer.

An embodiment of the present invention provides a fuel cell system that includes at least one electricity generating unit that includes an MEA including a polymer electrolyte membrane and the above-described electrodes positioned on both sides of the polymer electrolyte membrane. Separators are positioned on both sides of the MEA. The MEA generates electricity through an electrochemical reaction of a fuel and an oxidant. In addition, the fuel cell system includes a fuel supplying unit for supplying hydrogen or a fuel including hydrogen to the electricity generating unit and an oxidant supplying unit for supplying an oxidant to the electricity generating unit.

An embodiment of the present invention provides a fuel cell system that includes at least one electricity generating unit that includes an MEA including a polymer electrolyte membrane having first and second side surfaces, wherein nano-carbon is formed on the first and second side surfaces of the polymer electrolyte membrane and a catalyst layer is coated on the nano-carbon. Electrode substrates are positioned on the first and second side surfaces of the polymer electrolyte membrane to form the MEA. A separator is positioned on each side of the MEA. The MEA generates electricity through an electrochemical reaction of a fuel and an oxidant. In addition, the fuel cell system includes a fuel supplying unit for supplying hydrogen or a fuel including hydrogen to the electricity generating unit and an oxidant supplying unit for supplying an oxidant to the electricity generating unit.

An embodiment of the present invention provides a method of preparing an electrode for a fuel cell. The method includes forming a microporous layer on a surface of an electrode substrate; introducing a first catalyst for synthesizing nano-carbon on a surface of the microporous layer; heating the first catalyst locally while providing a reactive gas including a carbon source gas on the first catalyst to grow nano-carbon on the surface of the microporous layer; and coating a second catalyst on the nano-carbon to form a catalyst layer.

An embodiment of the present invention provides a method of preparing an MEA for a fuel cell. The method includes introducing a first catalyst for synthesizing nano-carbon on first and second side surfaces of a polymer membrane; heating the first catalyst locally while providing a reactive gas including a carbon source gas on the first catalyst to grow the nano-carbon on the first and second side surfaces of the polymer membrane; and coating a second catalyst on the nano-carbon to form a catalyst layer. Electrodes are then positioned on the first and second side surfaces of the polymer membrane.

### BRIEF DESCRIPTION OF THE DRAWINGS

FIG. 1A is a schematic cross-sectional view showing an electrode substrate before it has been coated with catalyst;

FIG. 1B is a schematic cross-sectional view showing an electrode for a fuel cell with a catalyst coated thereon in accordance with an embodiment of the present invention;

FIG. 2 is a schematic cross-sectional view showing an electrode for a fuel cell in accordance with another embodiment of the present invention;

FIG. 3 is a schematic cross-sectional view depicting an electrode-membrane assembly for a fuel cell in accordance with an embodiment of the present invention;

FIG. 4 is an exploded perspective view of a stack which includes an electrode of an embodiment of the present invention;

FIG. 5 is a schematic view showing a fuel cell system according to the present invention; and

FIG. 6 is a graph showing current density and voltage of fuel cells according to Example 1 and Comparative Examples 1 and 2.

### DETAILED DESCRIPTION

Typically, expensive noble metals are used as metal catalysts for an MEA of a fuel cell. Among the noble metals, platinum is used widely. Because platinum is a rare and expensive metal, it is desirable to reduce the quantity of the metal catalyst while maintaining the performance of the fuel cell.

A method for reducing the amount of the metal catalyst is to deposit the metal catalyst on a substrate to thereby form a catalyst layer. However, the surface area of the catalyst layer depends on the surface area of the substrate on which the catalyst is deposited. If the catalyst layer has a small surface area, the output characteristic of a fuel cell is degraded. Thus, an embodiment of the present invention provides a system and method to enlarge the surface area of the substrate where the catalyst is deposited.

In an electrode according to an embodiment of the present invention, the amount of metal catalyst can be significantly reduced, while the surface area of the metal catalyst can be increased by maximizing the surface area of the electrode substrate and coating the catalyst thereon.

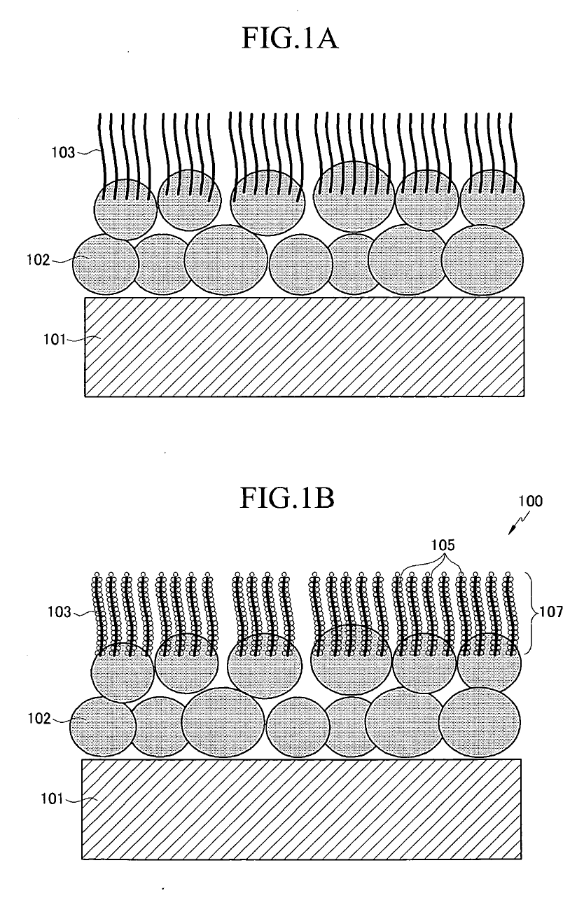

FIG. 1A is a schematic cross-sectional view showing an electrode substrate with a maximized specific surface area, and FIG. 1B is a schematic cross-sectional view showing an electrode for a fuel cell that has a catalyst coated on the surface of the electrode substrate in accordance with an embodiment of the present invention.

Referring to FIGS. 1A and 1B, an electrode 100 for a fuel cell includes an electrode substrate 101, a microporous layer 102 formed on the surface of the electrode substrate 101, and a catalyst layer 107 including nano-carbon 103 formed on the surface of the microporous layer 102 and catalyst 105 coated on the surface of the nano-carbon 103.

The electrode substrate 101 supports the electrode 100, and provides a path for transferring the fuel and oxidant to the catalyst 105. In one embodiment, the electrode substrate 101 is formed from a material such as carbon paper, carbon cloth, or carbon felt. Because the electrode substrate 101 also diffuses reactants to the catalyst layer 107, it can be referred to as a diffusion layer.

In one embodiment, the diffusion layer of the electrode substrate 101 has a preferred thickness between about 10 μm and 1000 μm, and more preferably, the thickness is between about 10 μm and 700 μm. When the diffusion layer has a thickness of less than 10 μm, it cannot serve as a supporter. When the diffusion layer has a thickness of more than 1000 μm, the fuel and oxidants cannot be supplied smoothly.

As shown, the electrode 100 further includes a microporous layer 102 for improving diffusion of reactants. The microporous layer 102 can have a roughness factor of about 5 to 100. The roughness factor is a value obtained by dividing the surface area of the microporous layer 102 by the geometric area of the microporous layer 102. When the roughness factor is less than 5, the amount of nano-carbon 105 formed on the microporous layer 102 is too small to perform its required function, and it is difficult to form a roughness of more than 100.

The microporous layer 102 supplies reactants to the catalyst layer 107, and transfers electrons which are formed on the catalyst layer 107 to a polymer membrane of the fuel cell. In one embodiment, the microporous layer 102 includes a conductive material such as carbon powder, graphite, fullerene (C60), carbon black, acetylene black, activated carbon, nano-carbon, or combinations thereof. The nano-carbon may include a material such as carbon nanotube, carbon nanofiber, carbon nanowire, carbon nanohorn, carbon nanoring, or combinations thereof.

In one embodiment, the microporous layer 102 has a preferred thickness between about 1 μm and 100 μm, and more preferred, between about 1 μm and 80 μm. When the microporous layer has a thickness of less than 1 μm, the fuels or oxidants cannot be diffused effectively. When it has a thickness of more than 100 μm, the fuels or oxidants cannot be supplied smoothly.

The catalyst layer 107 is formed on the surface of the microporous layer 102, and includes nano-carbon 103 and catalyst 105 which are coated on the surface of the nano-carbon 103.

The nano-carbon 103 may be in the form of carbon nanotube (CNT), carbon nanofiber, carbon nanowire, carbon nanohorn, carbon nanoring or combinations thereof.

In one embodiment, the nano-carbon 103 is grown in a direction perpendicular to the surface of the microporous layer 102, and directly on the surface of the microporous layer 102.

In one embodiment, the nano-carbon 103 has a diameter between about 1 and 500 nm and a length between about 50 and 5000 nm. Typically, the smaller the diameter for the nano-carbon 103, the better it is. However, fabricating nano-carbon with a diameter smaller than 1 nm is difficult. When the diameter is larger than 500 nm, the effect of increasing the surface area is small. Also, when the nano-carbon 103 has a length shorter than 50 nm, the surface area of the nano-carbon 103 is low, which makes it hard to supply fuel. When the nano-carbon 103 has a length longer than 500 nm, the reactant diffusion is not smooth, and coating the catalyst 105 on the entire surface of the nano-carbon 103 is difficult.

In one embodiment, the catalyst layer 107 has a thickness between about 0.05 μm and 10 μm. When the catalyst layer 107 has a thickness of less than 0.05 μm, the surface area does not increase sufficiently. When it has a thickness of more than 10 μm, the surface increasing effect is saturated and unfavorably induces an increase in the thickness of the electrode 100.

In one embodiment, the amount of catalyst 105 included in the catalyst layer 107 is preferably between about 0.001 and 0.5 mg/cm², more preferably between about 0.001 and 0.2 mg/cm², and even more preferably between about 0.01 and 0.05 mg/cm². When the amount of catalyst 105 included in the catalyst layer 107 is less than 0.001 mg/cm², the fuel cell does not have sufficient efficiency. When the catalyst content exceeds 0.5 mg/cm², the utilization of the catalyst 105 can be degraded, and porosity of the catalyst layer 107 decreases, resulting in inhibition of reactant diffusion.

A catalyst layer in a conventional fuel cell is formed by coating a slurry including a catalyst, a binder, and a solvent on an electrode substrate using a wet coating technology. In order to obtain a desired efficiency for the conventional fuel cell, the content of the catalyst needs to be more than 0.5 mg/cm² per unit area. In a fuel cell of the present invention, the catalyst layer is formed on a nano-carbon surface and thus sufficient efficiency can be obtained while the content of the catalyst per unit area is reduced as compared with a conventional fuel cell.

In one embodiment of a fuel cell of the present invention, the specific surface area of the catalyst included in the catalyst layer 107 is preferably between about 10 and 500 m²/g, or more preferably between about 50 and 500 m²/g. Since the oxidation/reduction reaction of the fuel cell occurs on the surface of the catalyst, the fuel cell has excellent efficiency as it has a large specific surface area per unit weight. However, when the specific surface area per unit weight is smaller than 10 m²/g, the fuel cell has poor efficiency. When the specific surface area per unit weight is more than 500 m²/g, it is difficult to fabricate the fuel cell.

In one embodiment and referring now back to FIG. 1B, the catalyst layer 107 is formed by forming nano-carbon 103 on the microporous layer 102 and coating the metal catalyst 105 on the surface of the nano-carbon 103. Suitable catalysts 105 include platinum, ruthenium, osmium, platinum-transition metal alloys, and combinations thereof. The transition metal can include Ru, Os, Co, Pd, Ga, Ti, V, Cr, Mn, Fe, Co, Ni, Cu, or Zn.

The catalyst 105 is coated on the surface of the nano-carbon 103 using any one of a number of methods that include sputtering, physical vapor deposition (PVD), plasma enhanced chemical vapor deposition (PECVD), thermal chemical vapor deposition, electron beam evaporation, vacuum thermal evaporation, laser ablation, and thermal evaporation.

Hereinafter, a method for a preparing an electrode for a fuel cell in accordance with a first embodiment of the present invention is described in more detail.

Referring to FIGS. 1A and 1B, the microporous layer 102 is first formed on a surface of the electrode substrate 101. The electrode substrate 101 should be treated with a water-repellent agent such as polytetrafluoroethylene (PTFE). The microporous layer 102 is prepared by coating a composition including conductive materials, a binder resin, and a solvent on the electrode substrate 101. Suitable conductive material includes carbon, graphite, fullerene (C60), carbon black, acetylene black, activated carbon, and nano-carbon, such as carbon nanotube, carbon nanofiber, carbon nanowire, carbon nanohorn, carbon nanoring. The binder resin may be formed from materials such as polytetrafluoroethylene (PTFE), polyvinylidene fluoride, a copolymer of polyvinylidene fluoride and hexafluoropropylene (PVdF-HFP), polyvinylalcohol, or cellulose acetate. Suitable solvents include alcohols such as ethanol, isopropyl alcohol, ethyl alcohol, n-propyl alcohol, and butyl alcohol, water, dimethyl acetamide (DMAc), dimethylformamide, dimethylsulfoxide (DMSO), N-methylpyrrolidone, and tetrahydrofuran. The coating may be performed using a method such as screen printing, spray printing, coating using a doctor blade, gravure coating, dip coating, a silk screen method, or painting according to viscosity of the coating composition, but is not limited thereto.

In order to grow the nano-carbon 103, a first catalyst for synthesizing the nano-carbon 103 is introduced on the surface of the microporous layer 102. Examples of the first catalyst include Fe, Ni, Co, Y, Pd, Pt, Au, Pd, Ga, Ti, V, Cr, Mn, Cu, Ta, W, Mo, Al, and alloys thereof, and metal-containing carbides, borides, oxides, nitrides, sulfides, sulfates, and nitrates. Preferred first catalysts include Fe, Ni, alloys thereof, and metal-containing carbides, borides, oxides, nitrides, sulfides, sulfates, and nitrates.

In one embodiment, the first catalyst may be introduced by methods such as electrophoresis, or thermal spraying, and is dispersed uniformly on the surface of the microporous layer 102.

The substrate 101 on which nano-carbon 103 is grown should have a large surface area so that the nano-carbon 103 may provide a large surface area. Substrates such as carbon paper, carbon cloth, and carbon felt have a non-uniform surface, and thus cannot increase the surface of the nano-carbon 103 sufficiently. Therefore, in an embodiment of the present invention, in order to obtain a large surface for the nano-carbon 103, the microporous layer 102 is first formed on the surface of the electrode substrate 101.

After the first catalyst for synthesizing the nano-carbon 103 is introduced on the surface of the microporous layer 102, the first catalyst is heated locally while providing a reactive gas including a carbon source gas on the first catalyst, thereby synthesizing the nano-carbon 103 on the surface of the microporous layer 102.

Examples of the carbon source gas include hydrocarbon gases, such as ethylene, acetylene, and methane, carbon monoxide and carbon dioxide. The carbon source gas can also be introduced along with an inert gas such as nitrogen or argon.

The local heating process can be performed by methods such as microwave irradiation, electromagnetic induced heating, laser heating, and high frequency (RF) heating.

The synthesis of the nano-carbon may also be performed by using an electrode substrate upon which a microporous layer is formed and a synthesizing apparatus including a reactor where the nano-carbon is synthesized by a first catalyst; a supply of reactive gas; and a local heating unit for heating the first catalyst.

Direct synthesis of the nano-carbon on the substrate using deposition methods should be performed at a high temperature of more than about 600° C. However, during such a high temperature deposition, the polymer used for the water-repellent treatment of the electrode substrate or the binder resin for formation of the microporous layer may be decomposed. In one embodiment of the present invention, the nano-carbon can be grown at room temperature (25° C.) or another relatively low temperature by heating the first catalyst locally, thereby reducing polymer decomposition.

A catalyst layer is formed by coating a second catalyst on the nano-carbon. Suitable materials for the second catalyst include platinum, ruthenium, osmium, and platinum-transition metal alloys, where suitable transition metals include Ru, Os, Co, Pd, Ga, Ti, V, Cr, Mn, Fe, Co, Ni, Cu, and Zn. Suitable deposition methods include sputtering, physical vapor deposition (PVD), plasma enhanced chemical vapor deposition (PECVD), thermal chemical vapor deposition, electron beam evaporation, vacuum thermal evaporation, laser ablation, and thermal evaporation. However, the deposition is not limited to the above-listed methods. If necessary, a combination of the above-listed methods can be used.

After coating the second catalyst, the first catalyst should be removed in order to improve the efficiency of the second catalyst. The first catalyst can be removed by using a process such as an acid treatment. For the acid treatment, an acid such as nitric acid, sulfuric acid, hydrochloric acid, or acetic acid may be used.

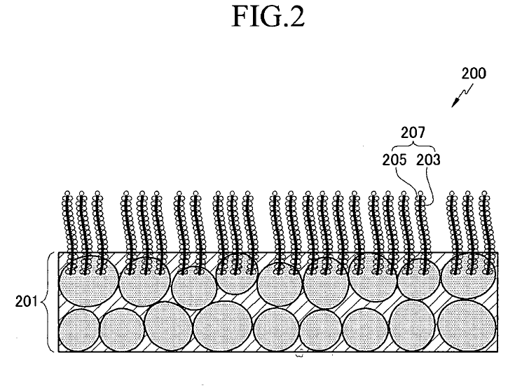

According to another embodiment, the electrode substrate and the microporous layer may be combined. Referring to FIG. 2, the electrode 200 includes an electrode substrate 201 including carbon particles dispersed therein to function both as a backing layer (e.g., an electrode substrate) and a dispersion layer (e.g., a microporous layer) and a catalyst layer 207. The catalyst layer 207 includes nano-carbon 203 formed on a surface of the electrode substrate 201, and a catalyst 205 coated on a surface of the nano-carbon 203. The nano-carbon 203 and the catalyst 205 are the same as described above.

According to another embodiment of the invention, an MEA is provided that includes the above described electrode. The MEA is prepared by positioning one of the above described electrodes on each side of the polymer electrolyte membrane.

According to still another embodiment of the invention, the MEA can be prepared by coating nano-carbon on the first and second side surfaces of the polymer membrane, coating a catalyst thereon, and then positioning electrode substrates on the first and second side surfaces of the coated polymer membrane.

The coating of the nano-carbon and the catalyst on the MEA can be performed in substantially the same way as described above in preparing the electrode for a fuel cell. That is, in order to grow the nano-carbon on the surface of the polymer membrane, a first catalyst for synthesizing the nano-carbon is introduced. Examples of the first catalyst include Fe, Ni, Co, Y, Pd, Pt, Au, Pd, Ga, Ti, V, Cr, Mn, Cu, Ta, W, Mo, Al, alloys thereof, and metal-containing carbides, borides, oxides, nitrides, sulfides, sulfates, and nitrates. Preferred first catalysts include Fe, Ni, alloys thereof, and metal-containing carbides, borides, oxides, nitrides, sulfides, sulfates, and nitrates.

In one embodiment, the first catalyst may be introduced by methods that include electrophoresis, thermal spraying and sputtering, and is dispersed uniformly on the surface of the polymer electrolyte membrane.

After the first catalyst for synthesizing nano-carbon is introduced on the surface of the polymer electrolyte membrane, the first catalyst is heated locally while providing a reactive gas including a carbon source gas on the first catalyst. By this method, the nano-carbon is directly synthesized on the surface of the polymer electrolyte membrane.

Examples of the carbon source gas include hydrocarbon gases such as ethylene, acetylene, and methane, carbon monoxide and carbon dioxide. The carbon source gas may also be introduced along with an inert gas such as nitrogen or argon.

The local heating process may be performed by microwave irradiation, electromagnetic induced heating, laser heating, or high frequency (RF) heating, but is not limited thereto.

The synthesis of the nano-carbon may also be performed by using a polymer electrolyte membrane and a synthesizing apparatus including a reactor where the nano-carbon is synthesized by a first catalyst; a supply of reactive gas; and a local heating unit for heating the first catalyst.

Direct synthesis of the nano-carbon on the substrate using deposition should be performed at a high temperature of more than 600° C. However, at such a high temperature the polymer electrolyte membrane may be decomposed. In one embodiment of the present invention, the nano-carbon may be grown at room temperature (25° C.) or another relatively low temperature by heating the first catalyst locally, thereby reducing decomposition of the polymer electrolyte membrane.

A catalyst layer is formed by coating a second catalyst on the nano-carbon formed on the surface of the polymer electrolyte membrane. Suitable choices for the second catalyst include platinum, ruthenium, osmium, and platinum-transition metals where suitable transition metals include Ru, Os, Co, Pd, Ga, Ti, V, Cr, Mn, Fe, Co, Ni, Cu, and Zn. The second catalyst may be coated using a deposition method selected from sputtering, physical vapor deposition (PVD), plasma enhanced chemical vapor deposition (PECVD), thermal chemical vapor deposition, electron beam evaporation, vacuum thermal evaporation, laser ablation, and thermal evaporation. However, the deposition is not limited to the above-listed methods. If necessary, a combination of the above-listed methods can be used.

After coating the second catalyst, the first catalyst should be removed in order to improve efficiency of the second catalyst. The first catalyst may be removed using acid treatment. Examples of acids used for the acid treatment include nitric acid, sulfuric acid, hydrochloric acid, and acetic acid.

The present invention also provides a fuel cell system including an MEA described above.

According to still another embodiment of the invention, the fuel system includes at least one electricity generating unit, a fuel supplying unit, and an oxidant supplying unit. The electricity generating unit includes an MEA including a polymer electrolyte membrane and the above described electrodes according to the first embodiment respectively positioned on both sides of the polymer electrolyte membrane, and separators respectively positioned on both sides of the MEA. The electricity generating unit generates electricity through an electrochemical reaction of hydrogen and an oxidant. The fuel supplying unit is for supplying hydrogen or a fuel including hydrogen to the electricity generating unit, and the oxidant supplying unit is for supplying an oxidant to the electricity generating unit.

According to still another embodiment of the invention, a fuel cell system includes at least one electricity generating unit, a fuel supplying unit, and an oxidant supplying unit. The electricity generating unit includes an MEA including a polymer electrolyte membrane, nano-carbon formed on the first and second side surfaces of the polymer electrolyte membrane, catalyst coated on the surface of the nano-carbon to form a catalyst layer, and electrode substrates positioned on the first and second side surfaces of the polymer electrolyte membrane. Separators are positioned on both sides of the MEA. The electricity generating unit generates electricity through an electrochemical reaction between hydrogen and an oxidant. The fuel supplying unit is for supplying hydrogen or a fuel including hydrogen to the electricity generating unit, and the oxidant supplying unit is for supplying an oxidant to the electricity generating unit.

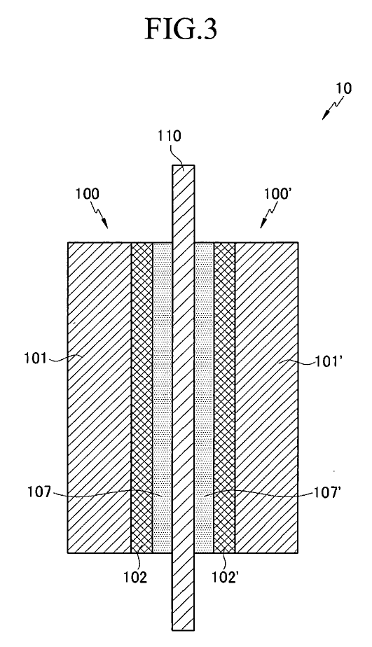

FIG. 3 is a schematic cross-sectional view illustrating an MEA including an electrode for a fuel cell in accordance with the first embodiment of the present invention. Referring to FIG. 3, an MEA 10 includes a polymer electrolyte membrane 110 and an anode 100 and cathode 100′ which are positioned on both surfaces of the polymer electrolyte membrane 110. At the anode 100, an oxidation reaction of fuel occurs to generate protons, H⁺, and electrons, e⁻. The polymer electrolyte membrane 110 transmits the generated protons to the cathode 100′. The transmitted protons on the cathode 100′ are electrochemically reacted with an oxidant supplied on the cathode 100′ to generate water.

The polymer electrolyte membrane 110 is made of a proton-conducting polymer. Exemplary materials for the polymer electrolyte membrane 110 include perfluoro-based polymers, benzimidazole-based polymers, polyimide-based polymers, polyetherimide-based polymers, polyphenylene sulfide-based polymers, polysulfone-based polymers, polyethersulfone-based polymers, polyetherketone-based polymers, polyether-etherketone-based polymers, and polyphenylquinoxaline-based polymers. Suitable proton-conducting polymers include poly(perfluorosulfonic acid), poly(perfluorocarboxylic acid), co-polymers of tetrafluoroethylene and fluorovinylether containing sulfonic acid groups, defluorinated polyetherketone sulfides, aryl ketones, poly(2,2′-(m-phenylene)-5,5′-bibenzimidazole), and poly(2,5-benzimidazole).

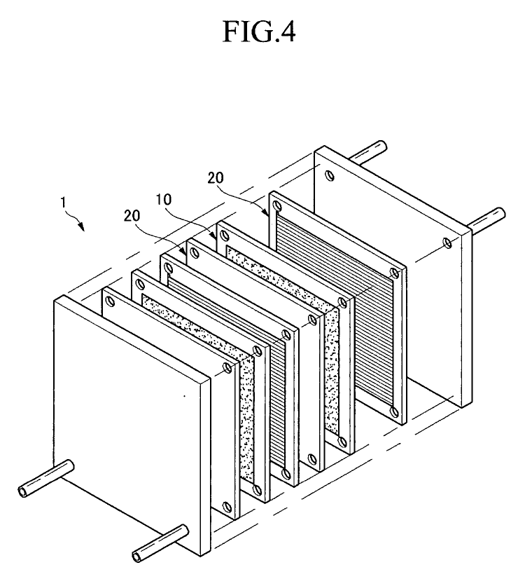

Separators are positioned on both sides of the MEA 10 to form an electricity generating unit. Through the separators, fuels and oxidants are supplied to the catalyst layers 107, 107′ via the microporous layers 102, 102′ and electricity is generated through the electrochemical reaction of fuels and oxidants. In general, at least two electricity generating units may be stacked to form a stack. FIG. 4 is a schematic exploded perspective view illustrating a stack. Referring to FIG. 4, the stack 1 includes an MEA 10 with separators 20 positioned on both sides of the MEA 10.

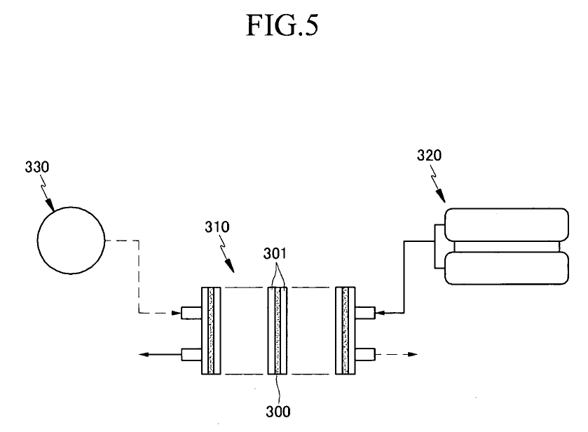

FIG. 5 shows the schematic structure of a fuel cell system of the present invention. Referring to FIG. 5, a fuel cell system includes an electricity generating unit 310, a fuel supplying unit 320, and an oxidant supplying unit 330. The electricity generating unit 310 includes a membrane-electrode assembly 300, and separators 301 to be positioned at both sides of the membrane-electrode assembly 300.

The fuel and oxidant are provided to the electricity generating unit through pumps or in a diffusion manner.

The fuel cell system of the present invention may be a phosphoric acid type, a polymer electrolyte type, or an alkaline type. It may further be a Polymer Electrolyte Membrane Fuel Cell (PEMFC) system or a Direct Methanol Fuel Cell (DMFC) system.

The following examples illustrate the present invention in further detail. However, it is understood that the present invention is not limited by these examples.

### EXAMPLE 1

3 g of carbon black, 0.2 g of polytetrafluoroethylene (PTFE), and 20 g of water as a solvent were mixed to prepare a composition. The composition was coated on a 200 μm-thick carbon cloth that was treated with PTFE to form a microporous layer. On the surface of the microporous layer, Fe as a first catalyst was dispersed in an amount of 0.02 mg/cm² by sputtering. The Fe-dispersed carbon cloth was placed on a quartz boat of a reactor mounted with a microwave generator. Acetylene gas as a carbon source and argon gas were introduced into the reactor at room temperature for 20 minutes to grow carbon nanotubes having a diameter of about 10 nm and a length of about 2000 nm. The microwaves were controlled to irradiate the Fe selectively to heat it locally.

On the surface of the carbon nanotubes, Pt was deposited to fabricate an electrode. The electrode was dipped in 20 wt % of nitric acid for 2 hours to remove the remaining Fe. The fabricated electrode had a Pt content per unit area of 0.05 mg/cm² and a surface area of 35 m²/g.

Subsequently, an MEA was fabricated by positioning and joining the electrodes for a fuel cell on both sides of a poly(perfluorosulfonic acid) membrane of Nafion® 112 material produced by the DuPont Company. A stack was fabricated by positioning separators on both sides of MEAs and stacking them. A fuel cell was fabricated by connecting a fuel supply unit including a fuel tank, a fuel pump, and an oxygen pump to the stack.

### EXAMPLE 2

A fuel cell was fabricated by the same method as in Example 1, except that Ni was used as a first catalyst.

### EXAMPLE 3

A fuel cell was fabricated by the same method as in Example 1, except that carbon nanofibers were grown as the nano-carbon instead of the carbon nanotubes.

### EXAMPLE 4

A fuel cell was fabricated by the same method as in Example 1, except that carbon nanowires were grown as the nano-carbon instead of the carbon nanotubes.

### EXAMPLE 5

0.5 g of carbon black, 0.5 g of polytetrafluoroethylene (PTFE), and 49 g of water as a solvent were mixed to prepare a composition. The composition was coated on a 200 μm-thick carbon cloth that was treated with PTFE to fabricate an electrode substrate in which the carbon black was dispersed. On the surface of the electrode substrate, Fe as a first catalyst was dispersed in an amount of 0.02 mg/cm² by sputtering. The Fe-dispersed carbon cloth was placed on a quartz boat of a reactor mounted with a microwave generator. Acetylene gas as a carbon source and argon gas were introduced into the reactor at room temperature for 20 minutes to grow carbon nanotubes having a diameter of about 10 nm and a length of about 2000 nm. The microwaves were controlled to irradiate the Fe selectively to heat it locally.

On the surface of the carbon nanotubes, Pt was deposited to fabricate an electrode. The electrode was dipped in 20 wt % of nitric acid for 2 hours to remove the remaining Fe. The fabricated electrode had a Pt content per unit area of 0.05 mg/cm² and a surface area of 35 m²/g.

Subsequently, an MEA was fabricated by positioning and joining the electrodes for a fuel cell on both sides of a poly(perfluorosulfonic acid) membrane of Nafion® 112 material produced by the DuPont Company. A stack was fabricated by positioning separators on both sides of MEAs and stacking them. A fuel cell was fabricated by connecting a fuel supply unit including a fuel tank, a fuel pump, and an oxygen pump to the stack.

### COMPARATIVE EXAMPLE 1

A fuel cell was fabricated by the same method as in Example 1, except that the electrodes were fabricated by sputtering platinum directly on the surface of an approximately 200 μm-thick carbon cloth.

### COMPARATIVE EXAMPLE 2

A fuel cell was fabricated by the same method as in Example 1, except that the electrodes were fabricated by growing the carbon nanotubes directly on the surface of an approximately 200 μm-thick carbon cloth and sputtering platinum on the surface of the carbon nanotubes without first forming a microporous layer.

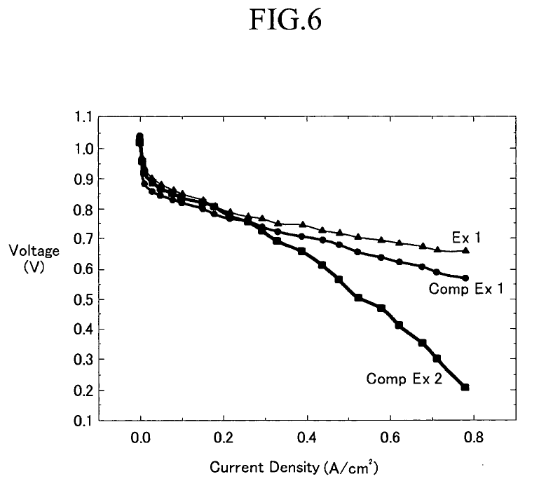

With respect to the fuel cells fabricated in accordance with the examples and comparative examples, about 50% humidified air and hydrogen were respectively supplied to the cathode and the anode, without back pressure, and the fuel cells were operated at about 60° C. The voltage and current density of the fuel cells of Example 1 and Comparative Examples 1 and 2 were measured and the results are given in FIG. 6. As can be seen from the measurement results, the fuel cell of Example 1, including the electrode where the nano-carbon was grown directly on a microporous layer and a catalyst was coated thereon, had a significantly better current density at a certain voltage compared with the fuel cells of Comparative Examples 1 and 2.

In view of the foregoing and according to an embodiment of the present invention, an electrode for a fuel cell has a large surface area such that a small quantity of catalyst can be used to provide high electrode reactivity and improved fuel cell performance.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. An electrode for a fuel cell comprising:
an electrode substrate;
a microporous layer on the electrode substrate;
a nano-carbon layer on the microporous layer; and
a catalyst layer on the nano-carbon layer.

2. The electrode for a fuel cell of claim 1, wherein the electrode substrate comprises a material selected from the group consisting of carbon paper, carbon cloth, and carbon felt.

3. The electrode for a fuel cell of claim 1, wherein the electrode substrate has a thickness between about 10 μm and 1000 μm.

4. The electrode for a fuel cell of claim 1, wherein the microporous layer has a thickness between about 1 μm and 100 μm.

5. The electrode for a fuel cell of claim 1, wherein the microporous layer comprises a material selected from the group consisting of carbon powder, graphite, fullerene (C60), carbon black, acetylene black, activated carbon, nano-carbon, carbon nanotube, carbon nanofiber, carbon nanowire, carbon nanohorn, and carbon nanoring.

6. The electrode for a fuel cell of claim 1, wherein the catalyst layer has a thickness between about 0.05 μm and 10 μm.

7. The electrode for a fuel cell of claim 1, wherein the nano-carbon of the nano-carbon layer is selected from the group consisting of carbon nanotubes (CNT), carbon nanofibers, carbon nanowires, carbon nanohorns, and carbon nanorings.

8. The electrode for a fuel cell of claim 1, wherein the nano-carbon layer is grown in a direction perpendicular to a surface of the microporous layer.

9. The electrode for a fuel cell of claim 1, wherein the nano-carbon is grown directly on a surface of the microporous layer.

10. The electrode for a fuel cell of claim 1, wherein the nano-carbon of the nano-carbon layer has a diameter between about 1 and 500 nm.

11. The electrode for a fuel cell of claim 1, wherein the catalyst layer is formed by depositing a metal catalyst on the nano-carbon of the nano-carbon layer.

12. The electrode for a fuel cell of claim 11, wherein the metal catalyst is deposited using a method selected from sputtering, physical vapor deposition (PVD), plasma enhanced chemical vapor deposition (PECVD), thermal chemical vapor deposition, electron beam evaporation, vacuum thermal evaporation, laser ablation, thermal evaporation, and combinations thereof.

13. The electrode for a fuel cell of claim 1, wherein the catalyst layer comprises a catalyst provided in an amount between about 0.001 and 0.5 mg/cm².

14. The electrode for a fuel cell of claim 13, wherein the catalyst is provided in an amount between about 0.01 and 0.05 mg/cm².

15. The electrode for a fuel cell of claim 1, wherein the catalyst layer comprises a catalyst with a specific surface area between about 10 and 500 m²/g.

16. The electrode for a fuel cell of claim 1, wherein the catalyst layer comprises a material selected from the group consisting of platinum, ruthenium, osmium, platinum-transition metal alloys, and combinations thereof.

17. The electrode for a fuel cell of claim 16, wherein the transition metal is selected from the group consisting of Ru, Os, Co, Pd, Ga, Ti, V, Cr, Mn, Fe, Co, Ni, Cu, Zn, and combinations thereof.

18. An electrode for a fuel cell comprising:
an electrode substrate having carbon particles dispersed therein;
a nano-carbon layer on the electrode substrate; and
a catalyst layer on the nano-carbon layer.

19. The electrode for a fuel cell of claim 18, wherein the electrode substrate having the carbon particles dispersed therein function both as a dispersion layer and a backing layer and comprises a material selected from the group consisting of carbon powder, graphite, fullerene (C60), carbon black, acetylene black, activated carbon, nano-carbon, carbon nanotube, carbon nanofiber, carbon nanowire, carbon nanohorn, and carbon nanoring.

20. The electrode for a fuel cell of claim 18, wherein the nano-carbon of the nano-carbon layer is selected from the group consisting of carbon nanotubes (CNT), carbon nanofibers, carbon nanowires, carbon nanohorns, and carbon nanorings.

21. A membrane-electrode assembly for a fuel cell, comprising a polymer electrolyte membrane; and at least two electrodes respectively positioned on both sides of the polymer electrolyte membrane, wherein each electrode comprises:
an electrode substrate,
a microporous layer on the electrode substrate;
a nano-carbon layer on the microporous layer; and
a catalyst layer on the nano-carbon layer.

22. The membrane-electrode assembly for a fuel cell of claim 21, wherein the polymer electrolyte membrane is a proton-conducting polymer selected from the group consisting of perfluoro-based polymers, benzimidazole-based polymers, polyimide-based polymers, polyetherimide-based polymers, polyphenylene sulfide-based polymers, polysulfone-based polymers, polyethersulfone-based polymers, polyetherketone-based polymers, polyether-etherketone-based polymers, and polyphenylquinoxaline-based polymers.

23. The membrane-electrode assembly for a fuel cell of claim 21, wherein the polymer electrolyte membrane is a proton-conducting polymer selected from the group consisting of poly(perfluorosulfonic acid), poly(perfluorocarboxylic acid), co-polymers of tetrafluoroethylene and fluorovinylether containing sulfonic acid groups, defluorinated polyetherketone sulfides, aryl ketones, poly(2,2′-(m-phenylene)-5,5′-bibenzimidazole), and poly(2,5-benzimidazole).

24. A membrane-electrode assembly for a fuel cell, comprising a polymer electrolyte membrane and at least two electrode substrates, wherein the polymer electrolyte membrane has first and second side surfaces and further comprises;
nano-carbon layers on the first and second side surfaces of the polymer electrolyte membrane; and
catalyst layers on the nano-carbon layers.

25. The membrane-electrode assembly for a fuel cell of claim 24, wherein the nano-carbon of the nano-carbon layers extend in directions perpendicular to the surfaces of the polymer electrolyte membrane.

26. The membrane-electrode assembly for a fuel cell of claim 24, wherein the nano-carbon layers are grown directly on the surfaces of the polymer electrolyte membrane.

27. The membrane-electrode assembly for a fuel cell of claim 24, wherein the polymer electrolyte membrane is a proton-conducting polymer selected from the group consisting of perfluoro-based polymers, benzimidazole-based polymers, polyimide-based polymers, polyetherimide-based polymers, polyphenylene sulfide-based polymers, polysulfone-based polymers, polyethersulfone-based polymers, polyetherketone-based polymers, polyether-etherketone-based polymers, and polyphenylquinoxaline-based polymers.

28. A fuel cell system comprising an electricity generating unit, a fuel supplying unit for supplying a fuel including hydrogen to the electricity generating unit; and an oxidant supplying unit for supplying an oxidant to the electricity generating unit, wherein the electricity generating unit comprises a plurality of membrane electrode assemblies and separators, and each membrane electrode assembly comprises a polymer electrolyte membrane between at least two electrodes, wherein at least one of the at least two electrodes comprises:
an electrode substrate;
a microporous layer on the electrode substrate;
a nano-carbon layer on the microporous layer; and
a catalyst layer on the nano-carbon layer.

29. The fuel cell system of claim 28, wherein the polymer electrolyte membrane is a proton-conducting polymer selected from the group consisting of perfluoro-based polymers, benzimidazole-based polymers, polyimide-based polymers, polyetherimide-based polymers, polyphenylene sulfide-based polymers, polysulfone-based polymers, polyethersulfone-based polymers, polyetherketone-based polymers, polyether-etherketone-based polymers, and polyphenylquinoxaline-based polymers.

30. A fuel cell system comprising an electricity generating unit, a fuel supplying unit for supplying a fuel including hydrogen to the electricity generating unit; and an oxidant supplying unit for supplying an oxidant to the electricity generating unit, wherein the electricity generating unit comprises a plurality of membrane electrode assemblies and separators, and each membrane electrode assembly comprises a polymer electrolyte membrane between at least two electrodes, wherein the polymer electrolyte membrane includes first and second surfaces and further comprises:
a microporous layer on at least one of the first and second surfaces;
a nano-carbon layer on the microporous layer; and
a catalyst layer on the nano-carbon layer.

31. A method of preparing an electrode for a fuel cell, the method comprising:
providing an electrode substrate;
forming a microporous layer on the electrode substrate;
providing a first catalyst for synthesizing nano-carbon on the microporous layer;
heating the first catalyst locally while exposing the first catalyst to a reactive gas including carbon to grow a nano-carbon layer on the microporous layer; and
coating a second catalyst on the nano-carbon layer.

32. The method of claim 31, wherein the electrode substrate is selected from the group consisting of carbon paper, carbon cloth, and carbon felt.

33. The method of claim 31, wherein the electrode substrate has a thickness between about 10 μm and 1000 μm.

34. The method of claim 31, wherein the microporous layer has a thickness between about 1 μm and 100 μm.

35. The method of claim 31, wherein the microporous layer comprises a material selected from the group consisting of carbon powder, graphite, fullerene (C60), carbon black, acetylene black, activated carbon, nano-carbon, carbon nanotube, carbon nanofiber, carbon nanowire, carbon nanohorn, and carbon nanoring.

36. The method of claim 31, wherein the first catalyst is selected from the group consisting of Fe, Ni, Co, Y, Pd, Pt, Au, Pd, Ga, Ti, V, Cr, Mn, Cu, Ta, W, Mo, Al, alloys thereof, and metal-containing carbides, borides, oxides, nitrides, sulfides, sulfates, and nitrates.

37. The method of claim 31, wherein the first catalyst is introduced by a method selected from electrophoresis, thermal spray method, and sputtering.

38. The method of claim 31, wherein the reactive gas is selected from the group consisting of hydrocarbon gases, carbon monoxide, and carbon dioxide.

39. The method of claim 31, wherein the local heating of the catalyst is performed by a method selected from microwave irradiation, electromagnetic induced heating, laser heating, and high frequency (RF) heating.

40. The method of claim 31, wherein the catalyst layer is formed to a thickness between 0.05 μm and 10 μm.

41. The method of claim 31, wherein the nano-carbon of the nano-carbon layer is selected from the group consisting of carbon nanotubes (CNT), carbon nanofibers, carbon nanowires, carbon nanohorns, and carbon nanorings.

42. The method of claim 31, wherein the nano-carbon of the nano-carbon layer is grown in a direction perpendicular to the microporous layer.

43. The method of claim 31, wherein the nano-carbon of the nano-carbon layer has a diameter between about 1 and 500 nm.

44. The method of claim 31, wherein the catalyst layer comprises a catalyst provided in an amount between about 0.001 and 0.5 mg/cm².

45. The method of claim 31, wherein the catalyst layer has a specific surface area between about 10 and 500 m²/g.

46. The method of claim 31, wherein the catalyst layer is formed by depositing a metal catalyst on the nano-carbon layer.

47. The method of claim 46, wherein the metal catalyst is deposited using a method selected from sputtering, physical vapor deposition (PVD), plasma enhanced chemical vapor deposition (PECVD), thermal chemical vapor deposition, electron beam evaporation, vacuum thermal evaporation, laser ablation, and thermal evaporation.

48. The method of claim 46, further comprising removing the first catalyst from the catalyst layer.

49. The method of claim 48, wherein the first catalyst is removed by acid treatment.

50. A method of preparing a polymer electrode membrane for a fuel cell comprising:
providing a polymer electrode membrane substrate;
providing a first catalyst for synthesizing nano-carbon on the polymer electrode membrane substrate;
heating the first catalyst locally while exposing the first catalyst to a reactive gas including carbon to grow a nano-carbon layer on the microporous layer; and
coating a second catalyst on the nano-carbon layer.
